(19) United States
(12) Patent Application Publication
(10) Pub. No.: US 2026/0369837 A1
(43) Pub. Date: Nov. 19, 2026

(54) SECONDARY BATTERY AND METHOD FOR MANUFACTURING SAME

(71) Applicant: Samsung SDI Co., Ltd., Yongin-si (KR)

(72) Inventors: Jaehyeon Yun, Yongin-si (KR); Seokyo Jeoung, Yongin-si (KR); Eunseok Oh, Yongin-si (KR); Hanbyeol Jang, Yongin-si (KR)

(73) Assignee: Samsung SDI Co., Ltd., Yongin-si (KR)

(21) Appl. No.: 19/672,919

(22) Filed: May 11, 2026

(30) Foreign Application Priority Data
May 13, 2025 (KR) 10-2025-0062170

(51) Int. Cl. H01M 50/55; H01M 10/058; H01M 50/105; H01M 50/119; H01M 50/531; H01M 50/586; H01M 50/627

(52) U.S. Cl. CPC H01M 50/55; H01M 10/058; H01M 50/119; H01M 50/531; H01M 50/586; H01M 50/627; H01M 50/105

(57) ABSTRACT

The present disclosure relates to a secondary battery. The secondary battery includes an electrode assembly including a first electrode, a second electrode, and a separator interposed between the first electrode and the second electrode, a first case including a receiving portion accommodating the electrode assembly and having an open end and a flange portion extending outward from the open end of the receiving portion, and a second case coupled to the flange portion to seal the open end of the receiving portion. A first electrode terminal electrically connected to the first electrode protrudes from a first side surface of the receiving portion. The first electrode terminal is disposed to be biased toward one side with respect to a central axis of the receiving portion along a direction in which the first electrode terminal protrudes.

### CROSS-REFERENCE TO RELATED APPLICATION

This present application claims priority to and the benefit under 35 U.S.C. § 119(a)-(d) of Korean Patent Application No. 10-2025-0062170, filed on May 13, 2025, in the Korean Intellectual Property Office, the entire disclosure of which is incorporated herein by reference.

### BACKGROUND

### Field

The present disclosure relates to a secondary battery and a method for manufacturing the same.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

A problem to be solved by the present disclosure is to provide a secondary battery and a method for manufacturing the same for solving the problems as described herein.

These and other aspects and features of the present disclosure will be described in or will be apparent from the following description of embodiments of the present disclosure.

According to some embodiments of the present disclosure for solving the technical problem, a secondary battery includes an electrode assembly including a first electrode, a second electrode, and a separator interposed between the first electrode and the second electrode, a first case including a receiving portion accommodating the electrode assembly and having an open end and a flange portion extending outward from the open end of the receiving portion, and a second case coupled to the flange portion to seal the open end of the receiving portion, wherein a first electrode terminal electrically connected to the first electrode protrudes from a first side surface of the receiving portion, the first electrode terminal is disposed to be biased toward one side with respect to a central axis of the receiving portion along a direction in which the first electrode terminal protrudes, and the flange portion extending from the first side surface may be cut to follow a shape in which the first electrode terminal protrudes.

According to some embodiments of the present disclosure, an electrolyte injection portion further protrudes from the first side surface, the electrolyte injection portion is disposed to be biased toward the one side on which the first electrode terminal is disposed with respect to the central axis, and the flange portion extending from the first side surface may be cut to follow a protruding shape of each of the first electrode terminal and the electrolyte injection portion.

According to some embodiments of the present disclosure, a first length by which the first electrode terminal is spaced apart from the central axis may be greater than or equal to a second length by which the electrolyte injection portion is spaced apart from the central axis.

According to some embodiments of the present disclosure, a first length by which the first electrode terminal protrudes from the first side surface may be greater than or equal to a second length by which the electrolyte injection portion protrudes from the first side surface.

According to some embodiments of the present disclosure, a second electrode terminal electrically connected to the second electrode further protrudes from the first side surface, the second electrode terminal is disposed to be biased toward the one side on which the first electrode terminal is disposed with respect to the central axis, and the flange portion extending from the first side surface may be cut to follow a protruding shape of each of the first electrode terminal, the electrolyte injection portion, and the second electrode terminal.

According to some embodiments of the present disclosure, a second length by which the electrolyte injection portion is spaced apart from the central axis may be less than or equal to a first length by which the first electrode terminal is spaced apart from the central axis and greater than or equal to a third length by which the second electrode terminal is spaced apart from the central axis.

According to some embodiments of the present disclosure, a second length by which the electrolyte injection portion protrudes from the first side surface may be less than or equal to a first length by which the first electrode terminal protrudes from the first side surface and greater than or equal to a third length by which the second electrode terminal protrudes from the first side surface.

According to some embodiments of the present disclosure, a second electrode terminal electrically connected to the second electrode further protrudes from the first side surface, the second electrode terminal is disposed to be biased toward the one side on which the first electrode terminal is disposed with respect to the central axis, and the flange portion extending from the first side surface may be cut to follow a protruding shape of each of the first electrode terminal and the second electrode terminal.

According to some embodiments of the present disclosure, a cutting line of the flange portion extending from the first side surface may be formed outside the protruding shape in which the first electrode terminal protrudes such that the flange portion extending from the first side surface protrudes further than the first electrode terminal by a predetermined length.

According to some embodiments of the present disclosure, the flange portion extending from a second side surface of the receiving portion may be cut to follow a shape of the second side surface.

According to some embodiments of the present disclosure, a cutting line of the flange portion extending from the second side surface may be formed outside the shape of the second side surface such that the flange portion extending from the second side surface protrudes further than the second side surface by a predetermined length.

According to some embodiments of the present disclosure, the secondary battery may further include an insulating member in which a through-hole is formed, and the insulating member may be disposed between the first side surface of the receiving portion and the electrode assembly.

According to some embodiments of the present disclosure, the electrode assembly may further include an electrode tab protruding toward one side of the first electrode to be connected to the first electrode terminal, and the electrode tab may pass through the insulating member through the through-hole.

According to some embodiments of the present disclosure, the through-hole may be formed to be biased toward one side with respect to a central axis of the insulating member along a direction in which the first electrode terminal protrudes, and may be disposed at a position corresponding to the first electrode terminal.

According to some embodiments of the present disclosure, at least a portion of the first case and the second case may include stainless steel.

According to some embodiments of the present disclosure for solving the technical problem, a method for manufacturing a secondary battery includes providing an electrode assembly including a first electrode, a second electrode, and a separator interposed between the first electrode and the second electrode, providing a first case including a receiving portion having an open end and a flange portion extending outward from the open end of the receiving portion, inserting the electrode assembly into the receiving portion through the open end, coupling a second case to the flange portion to seal the open end of the receiving portion, and cutting the flange portion, wherein a first electrode terminal electrically connected to the first electrode protrudes from a first side surface of the receiving portion, the first electrode terminal is disposed to be biased toward one side with respect to a central axis of the receiving portion along a direction in which the first electrode terminal protrudes, and the cutting the flange portion may include cutting the flange portion extending from the first side surface to follow a shape in which the first electrode terminal protrudes.

According to some embodiments of the present disclosure, an electrolyte injection portion further protrudes from the first side surface, the electrolyte injection portion is disposed to be biased toward the one side on which the first electrode terminal is disposed with respect to the central axis, and the cutting the flange portion may further include cutting the flange portion extending from the first side surface to follow a shape in which the electrolyte injection portion protrudes.

According to some embodiments of the present disclosure, the cutting to follow the shape in which the first electrode terminal protrudes may include forming a cutting line of the flange portion extending from the first side surface outside the protruding shape in which the first electrode terminal protrudes such that the flange portion extending from the first side surface protrudes further than the first electrode terminal by a predetermined length.

According to some embodiments of the present disclosure, the cutting the flange portion may further include cutting the flange portion extending from a second side surface of the receiving portion to follow a shape of the second side surface.

According to some embodiments of the present disclosure, the electrode assembly may further include an electrode tab protruding toward one side of the first electrode, the inserting includes providing an insulating member in which a through-hole is formed, inserting the electrode tab through the through-hole, and connecting the electrode tab to the first electrode terminal, and the through-hole may be formed to be biased toward one side with respect to a central axis of the insulating member along a direction in which the first electrode terminal protrudes, and may be disposed at a position corresponding to the first electrode terminal.

According to some embodiments of the present disclosure, as a flange portion of a secondary battery is cut along a protruding shape of a first electrode terminal, an electrolyte injection portion, or a second electrode terminal, dead space that does not contribute to the energy capacity of the secondary battery is minimized, so that the energy density of the secondary battery may be increased.

However, aspects and features of the present disclosure are not limited to those described above, and other aspects and features not mentioned will be clearly understood by a person skilled in the art from the detailed description, described.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is an exploded perspective view illustrating an example of a secondary battery according to embodiments of the present disclosure.

FIG. 2 is a perspective view illustrating an example of a secondary battery according to embodiments of the present disclosure.

FIG. 3 illustrates an example of a secondary battery according to embodiments of the present disclosure.

FIG. 4 is an enlarged view illustrating an example of a secondary battery according to embodiments of the present disclosure.

FIG. 5 is an enlarged view illustrating an example of a secondary battery according to embodiments of the present disclosure.

FIG. 6 is an enlarged view illustrating an example of a secondary battery according to embodiments of the present disclosure.

FIG. 7 is a flowchart illustrating a method for manufacturing a secondary battery according to embodiments of the present disclosure.

FIG. 8 illustrates an insertion process of an electrode assembly of a secondary battery according to embodiments of the present disclosure.

FIG. 9 illustrates an example of an insulating member according to embodiments of the present disclosure.

FIG. 10 illustrates a process in which a flange portion is cut according to embodiments of the present disclosure.

FIG. 11 illustrates a secondary battery according to embodiments of the present disclosure and a secondary battery according to a comparative example.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, sizes and relative sizes of regions shown in the drawings may be exaggerated for clarity of description. That is, the sizes shown in the drawings are only for convenience of understanding and are not limited thereto. In addition, the same reference numerals refer to the same components throughout the specification.

Recently, as customer needs for reduction in weight and size of secondary batteries used in portable IT devices, vehicles, and the like arise, research on small batteries and thin batteries is being actively conducted. Accordingly, efforts to reduce dead space inside and outside the battery continue. For example, a method for increasing the energy density of the battery by minimizing a portion that does not contribute to the battery capacity is being devised. Aspects of the technology described herein provide for techniques that increase the energy density of a battery.

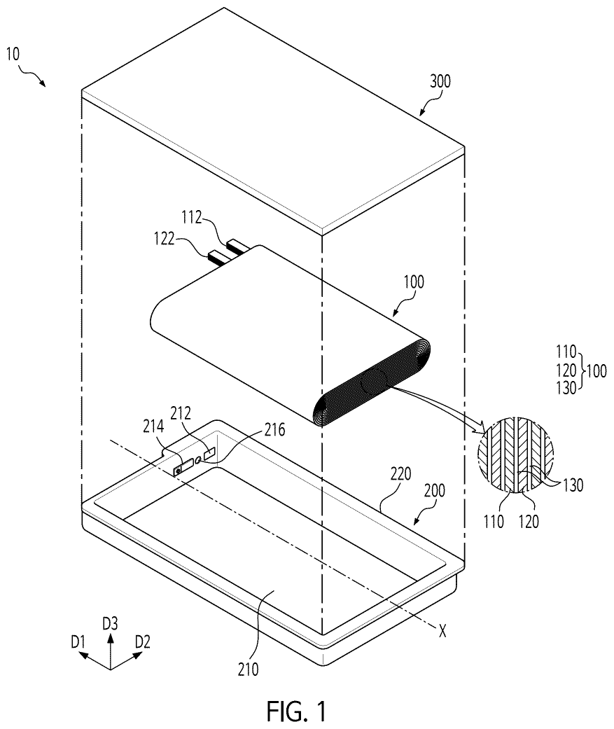

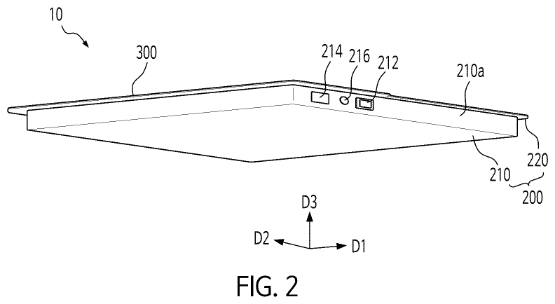

FIG. 1 is an exploded perspective view illustrating an example of a secondary battery 10 according to embodiments of the present disclosure, and FIG. 2 is a perspective view illustrating an example of the secondary battery 10 according to embodiments of the present disclosure. D1, D2, and D3 shown in FIGS. 1 and 2 may indicate a longitudinal direction, a width direction, and a thickness direction of the secondary battery 10 or a configuration of the secondary battery 10 (e.g., a first case 200, an electrode assembly 100, etc.), respectively.

Referring to FIGS. 1 and 2, the secondary battery 10 may include the electrode assembly 100, the first case 200 accommodating the electrode assembly 100, and a second case 300 sealing the first case 200.

The electrode assembly 100 may include a first electrode 110, a separator 130, and a second electrode 120. For example, the electrode assembly 100 may be wound or stacked with the separator 130, which is an insulator, interposed between the first electrode 110 and the second electrode 120.

The first electrode 110 may include a first substrate and a first active material layer positioned on the first substrate. A first electrode tab 112 may extend outward from a first uncoated region where the first active material layer is not positioned among the first substrate. The second electrode 120 may include a second substrate and a second active material layer positioned on the second substrate. A second electrode tab 122 may extend outward from a second uncoated region where the second active material layer is not positioned among the second substrate.

The first electrode 110 may function as a positive electrode. In this case, the first substrate may be a positive electrode substrate. The positive electrode substrate may be composed of aluminum foil, and a positive electrode active material may include, for example, a transition metal oxide.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L1_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_Fe₂(PO4)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The second electrode 120 may function as a negative electrode. In this case, the second substrate may be a negative electrode substrate. The negative electrode substrate may be composed of, for example, copper foil or nickel foil, and a negative electrode active material may include, for example, graphite.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

The separator may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

The first case 200 may include a receiving portion 210 and a flange portion 220. In a substantially central region of the first case 200, the receiving portion 210 in which the electrode assembly 100 is accommodated may be formed by press processing or the like. For example, the receiving portion 210 may have an open end (e.g., one surface in the D3 direction of the first case 200), and the electrode assembly 100 may be inserted through the open end of the receiving portion 210. The flange portion 220 may extend outward from the open end of the receiving portion 210.

The second case 300 may be coupled to the flange portion 220 to seal the open end of the receiving portion 210. The first case 200 and the second case 300 may be joined to form an appearance of the secondary battery 10. For example, the second case 300 may be composed of a flat plate disposed on an upper portion of the first case 200 to seal the open end of the receiving portion 210. The second case 300 may be formed as a flat plate having a size sufficient to cover at least a portion of the flange portion 220 to make surface contact with the flange portion 220.

In embodiments, the first case 200 and the second case 300 may be metal-joined (e.g., welding, brazing, soldering, etc.). In this case, the flange portion 220 of the first case 200 and an edge of the second case 300 may be joined. Further, after the first case 200 and the second case 300 are joined, at least a portion of the flange portion 220 may be cut by a laser to improve the energy density of the secondary battery 10.

In embodiments, the first case 200 and the second case 300 may be composed of the same metallic material. As the first case 200 and the second case 300 are composed of the same material, occurrence of corrosion at a site where the first case 200 and the second case 300 are coupled due to a potential difference between dissimilar metals may be prevented. However, the present disclosure is not limited thereto, and the first case 200 and the second case 300 may be composed of different metallic materials.

In embodiments, the metallic material constituting the first case 200 and the second case 300 may include stainless steel (SUS). The stainless steel material may be determined as any type of stainless steel-based material such as SUS 304, SUS 316, SUS 420, and SUS 430 according to the type and ratio of alloy materials within the stainless steel family. However, the present disclosure is not limited thereto, and the first case 200 and the second case 300 may be formed of a conductive metal such as aluminum, an aluminum alloy, or nickel-plated steel in some embodiments.

In embodiments, electrode terminals 212 and 214 may be disposed in the receiving portion 210 of the first case 200. For example, a first electrode terminal 212 and a second electrode terminal 214 may be formed to protrude from a first side surface 210a of the receiving portion 210. The first electrode terminal 212 may be electrically connected to the first electrode 110 through the first electrode tab 112. Further, the second electrode terminal 214 may be electrically connected to the second electrode 120 through the second electrode tab 122.

In embodiments, an electrolyte injection portion 216 may be disposed in the receiving portion 210 of the first case 200. For example, the electrolyte injection portion 216 may be formed to protrude from the first side surface 210a of the receiving portion 210. The electrolyte injection portion 216 may include a through-hole for injecting an electrolyte. For example, after the first case 200 and the second case 300 are joined and sealed, an electrolyte may be injected into the secondary battery 10 through the through-hole of the electrolyte injection portion 216. The through-hole of the electrolyte injection portion 216 may be sealed by a sealing member (e.g., a stopper, etc.) after the electrolyte is injected.

FIG. 1 illustrates the electrolyte injection portion 216 as being disposed between the first electrode terminal 212 and the second electrode terminal 214, but the present disclosure is not limited thereto and may have various modifications. For example, the first electrode terminal 212 may be disposed between the second electrode terminal 214 and the electrolyte injection portion 216, or the second electrode terminal 214 may be disposed between the first electrode terminal 212 and the electrolyte injection portion 216. Further, the first electrode terminal 212, the second electrode terminal 214, and the electrolyte injection portion 216 may be disposed on different surfaces of the receiving portion 210.

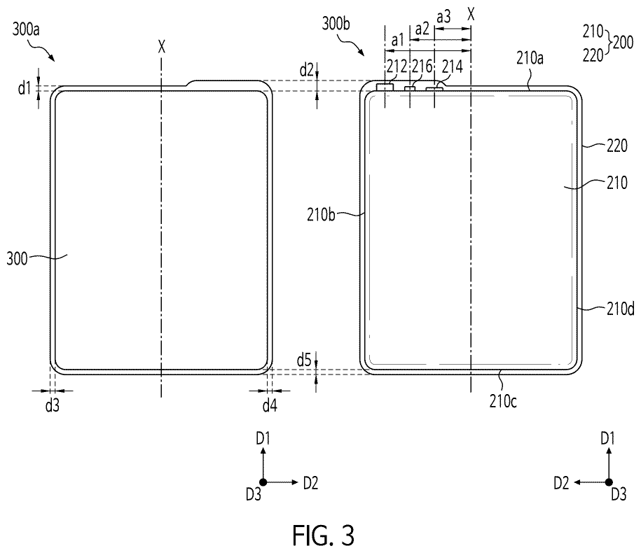

In embodiments, the first electrode terminal 212, the second electrode terminal 214, and the electrolyte injection portion 216 may protrude toward one side of the receiving portion 210. Further, the first electrode terminal 212, the second electrode terminal 214, and the electrolyte injection portion 216 may be disposed to be biased toward one side with respect to a central axis X of the receiving portion 210 along a direction (e.g., the D1 direction) in which the first electrode terminal 212 protrudes. Examples in which the first electrode terminal 212, the second electrode terminal 214, and the electrolyte injection portion 216 are disposed will be described later in further detail, for example, with reference to FIGS. 3-6.

The secondary battery 10 may be a lithium battery cell, a sodium battery cell, or the like. However, the scope of the present disclosure is not limited thereto, and the secondary battery 10 may include all types of batteries capable of repeatedly providing electricity by charging and discharging.

The configuration of the secondary battery shown in FIG. 1 is merely an example, and in some embodiments, configurations other than the illustrated configuration may be further included, and optionally some configurations may be omitted. Further, the shape, positional relationship, and the like of each configuration of the secondary battery 10 shown in FIG. 1 may be appropriately changed.

FIG. 3 illustrates an example of a secondary battery according to embodiments of the present disclosure. The secondary battery shown in a first example 300a and a second example 300b may be substantially the same as the secondary battery (e.g., 10 in FIGS. 1 and 2) shown in FIGS. 1 and 2. The first example 300a may be a view illustrating a state of the secondary battery viewed from the −D3 direction, and the second example 300b may be a view illustrating a state of the secondary battery viewed from the +D3 direction.

Referring to the first example 300a and the second example 300b, the secondary battery may include the first case 200 and the second case 300. The first case 200 and the second case 300 may be joined to form the appearance of the secondary battery. The first case 200 may include the receiving portion 210 in which the electrode assembly is accommodated and one end of which is open, and the flange portion 220 extending outward from the open end of the receiving portion 210. The second case 300 may be coupled to the flange portion 220 to seal the open end of the receiving portion 210.

In embodiments, the first electrode terminal 212, the second electrode terminal 214, and the electrolyte injection portion 216 may protrude toward the first side surface 210a of the receiving portion 210. Here, the first side surface 210a of the receiving portion 210 may refer to one of side surfaces 210a, 210b, 210c, and 210d surrounding the open end of the receiving portion 210. Further, the first side surface 210a may be a surface facing a surface from which the first electrode tab (e.g., 112 in FIG. 1) and the second electrode tab (e.g., 122 in FIG. 1) protrude in the electrode assembly accommodated in the first case 200. Accordingly, the first electrode tab and the second electrode tab of the electrode assembly may be electrically connected to the first electrode terminal 212 and the second electrode terminal 214 protruding from the first side surface 210a of the receiving portion 210, respectively.

In embodiments, the first electrode terminal 212 may be disposed to be biased toward one side (e.g., the +D2 direction) with respect to the central axis X of the receiving portion 210 along the direction (e.g., the D1 direction) in which the first electrode terminal 212 protrudes. The electrolyte injection portion 216 and the second electrode terminal 214 may also be disposed to be biased toward the same side as the one side (e.g., the +D2 direction) where the first electrode terminal 212 is biased with respect to the central axis X.

FIG. 3 illustrates that the first electrode terminal 212, the second electrode terminal 214, and the electrolyte injection portion 216 are all disposed to be biased toward the one side (e.g., the +D2 direction) with respect to the central axis X, but the present disclosure is not limited thereto. For example, the first electrode terminal 212, the second electrode terminal 214, and the electrolyte injection portion 216 may all be disposed to be biased toward the other side (e.g., the −D2 direction) with respect to the central axis X.

Further, in FIG. 3, the first electrode terminal 212, the second electrode terminal 214, and the electrolyte injection portion 216 are all illustrated and described as being formed to protrude from the first side surface 210a, but the present disclosure is not limited thereto. For example, at least one of the first electrode terminal 212, the second electrode terminal 214, and the electrolyte injection portion 216 may be disposed at the same height as the first side surface 210a so as not to protrude, or may be formed to be recessed inward (e.g., toward the inside of the receiving portion 210) from the first side surface 210a.

In embodiments, the first electrode terminal 212, the second electrode terminal 214, and the electrolyte injection portion 216 may be disposed to be spaced apart from each other. For example, a first length a1 by which the first electrode terminal 212 is spaced apart from the central axis X, a second length a2 by which the electrolyte injection portion 216 is spaced apart from the central axis X, and a third length a3 by which the second electrode terminal 214 is spaced apart from the central axis X may all be different. Further, the first electrode terminal 212, the second electrode terminal 214, and the electrolyte injection portion 216 may be disposed at a specific interval so as not to interfere with each other.

FIG. 3 illustrates that the first electrode terminal 212, the electrolyte injection portion 216, and the second electrode terminal 214 are sequentially arranged on the first side surface 210a of the receiving portion 210, but the present disclosure is not limited thereto, and the arrangement order of the first electrode terminal 212, the electrolyte injection portion 216, and the second electrode terminal 214 may be changed within a range in which the electrolyte injection portion 216 and the second electrode terminal 214 do not interfere with each other.

In embodiments, after the second case 300 is joined to the flange portion 220 to seal the first case 200, at least a portion of the flange portion 220 and/or the second case 300 may be cut. The flange portion 220 and/or the second case 300 may be cut along the side surfaces 210a, 210b, 210c, and 210d of the receiving portion 210.

In embodiments, the flange portion extending from the first side surface 210a of the receiving portion 210 from which the first electrode terminal 212 protrudes may be cut to follow a shape in which the first electrode terminal 212, the electrolyte injection portion 216, and/or the second electrode terminal 214 protrude. In this case, a cutting line of the flange portion extending from the first side surface 210a may be formed outside the first electrode terminal 212, the electrolyte injection portion 216, and the second electrode Terminal 214.

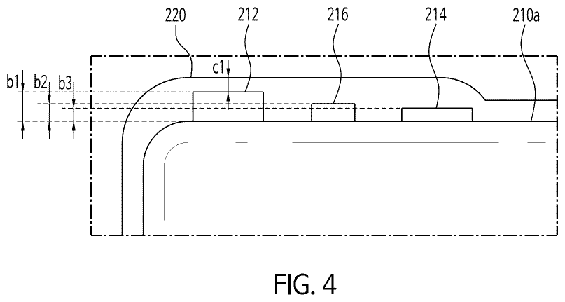

Further, a second cutting length d2 of the flange portion extending from a region where the first electrode terminal 212, the electrolyte injection portion 216, and the second electrode terminal 214 protrude may be longer than a first cutting length d1 of the flange portion extending from a region where the first electrode terminal 212, the electrolyte injection portion 216, and the second electrode terminal 214 do not protrude. In this case, due to a difference between the first cutting length d1 and the second cutting length d2, a step may be formed in the flange portion extending from the first side surface 210a. Specific examples thereof will be described in further detail, for example, with reference to FIGS. 4-6.

In embodiments, the flange portion extending from second side surfaces 210b, 210c, and 210d (e.g., remaining side surfaces of the receiving portion 210 except for the first side surface 210a) of the receiving portion 210 from which the first electrode terminal 212 does not protrude may be cut to follow a shape of the second side surfaces 210b, 210c, and 210d. In this case, a cutting line of the flange portion extending from the second side surfaces 210b, 210c, and 210d may be formed outside the second side surfaces 210b, 210c, and 210d. For example, cutting lengths d3, d4, and d5 of the flange portion extending from the second side surfaces 210b, 210c, and 210d may be within 0.3 mm of each other, but the cutting lengths are not limited thereto.

By such a configuration, as the flange portion 220 is cut along the protruding shapes of the first electrode terminal 212, the electrolyte injection portion 216, or the second electrode terminal 214, a dead space that does not contribute to the energy capacity of the secondary battery is minimized, thereby increasing the energy density of the secondary battery.

FIGS. 4-6 are enlarged views illustrating examples of a secondary battery according to embodiments of the present disclosure. FIGS. 4-6 are enlarged views illustrating a portion of the first side surface 210a of the receiving portion (e.g., 210 in FIG. 3) in an enlarged manner.

In embodiments, the first electrode terminal 212, the second electrode terminal 214, and the electrolyte injection portion 216 may protrude from the first side surface 210a of the receiving portion. In this case, a first length b1 by which the first electrode terminal 212 protrudes from the first side surface 210a, a second length b2 by which the electrolyte injection portion 216 protrudes from the first side surface 210a, and a third length b3 by which the second electrode terminal 214 protrudes from the first side surface 210a may all be different from one another. As a specific example, the second length b2 by which the electrolyte injection portion 216 protrudes from the first side surface 210a may be less than the first length b1 by which the first electrode terminal 212 protrudes from the first side surface 210a and greater than the third length b3 by which the second electrode terminal 214 protrudes from the first side surface 210a.

However, the present disclosure is not limited thereto, and at least two lengths among the first length b1, the second length b2, and the third length b3 may be the same. For example, the second length b2 by which the electrolyte injection portion 216 protrudes from the first side surface 210a may be less than or equal to the first length b1 by which the first electrode terminal 212 protrudes from the first side surface 210a and greater than or equal to the third length b3 by which the second electrode terminal 214 protrudes from the first side surface 210a.

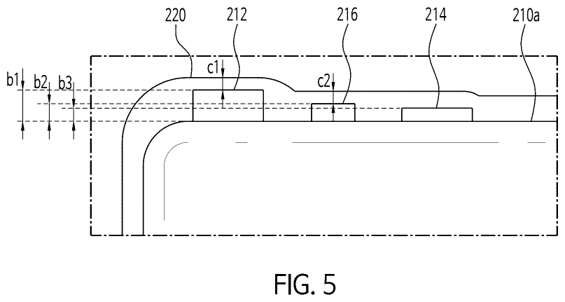

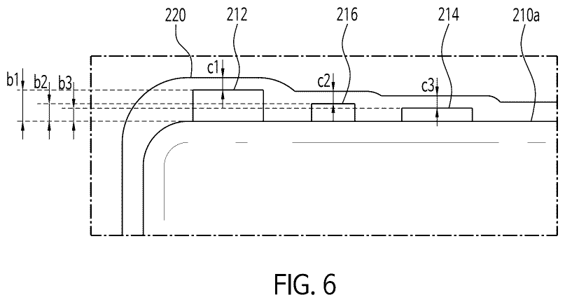

In embodiments, an order in which the first electrode terminal 212, the second electrode terminal 214, and the electrolyte injection portion 216 are disposed may be related to the lengths protruding from the first side surface 210a. For example, the first electrode terminal 212 having the longest length (e.g., b1) protruding from the first side surface 210a may be disposed at the outermost side (e.g., a side farthest from the central axis X in FIG. 3), and the second electrode terminal 214 having the shortest length (e.g., b3) protruding from the first side surface 210a may be disposed at the innermost side (e.g., a side closest to the central axis X in FIG. 3). Alternatively, the first electrode terminal 212 having the longest length (e.g., b1) protruding from the first side surface 210a may be disposed at the innermost side (e.g., a side closest to the central axis X in FIG. 3), and the second electrode terminal 214 having the shortest length (e.g., b3) protruding from the first side surface 210a may be disposed at the outermost side (e.g., a side farthest from the central axis X in FIG. 3). Through this, as will be described further including with reference to FIGS. 5 and 6, for example, the cutting line of the flange portion 220 may be optimized.

Referring to FIG. 4, the flange portion extending from the first side surface 210a of the receiving portion from which the first electrode terminal 212 protrudes may be cut to follow a shape in which the first electrode terminal 212 protrudes. In this case, the cutting line of the flange portion extending from the first side surface 210a may be formed outside the first electrode terminal 212, the electrolyte injection portion 216, and the second electrode terminal 214.

In embodiments, the cutting line of the flange portion extending from the first side surface 210a may be determined based on the first length b1 by which the first electrode terminal 212 protrudes from the first side surface 210a. For example, the cutting line of the flange portion extending from the region where the first electrode terminal 212, the electrolyte injection portion 216, and the second electrode terminal 214 protrude may be formed outside the shape in which the first electrode terminal 212 protrudes. In other words, the cutting line of the flange portion extending from the region where the first electrode terminal 212, the electrolyte injection portion 216, and the second electrode terminal 214 protrude may protrude further than the first electrode terminal 212 by a predetermined length c1. Here, the protrusion length c1 may be within 0.3 mm. As an example, the protrusion length c1 may be within 0.2 mm, but is not limited thereto.

In embodiments, the second cutting length (e.g., d2 in FIG. 3) of the flange portion extending from the region where the first electrode terminal 212, the electrolyte injection portion 216, and the second electrode terminal 214 protrude and the first cutting length (e.g., d1 in FIG. 3) of the flange portion extending from the region where the first electrode terminal 212, the electrolyte injection portion 216, and the second electrode terminal 214 do not protrude may be different from each other. For example, the second cutting length may be longer than the first cutting length. In this case, due to the difference between the first cutting length and the second cutting length, a one-stage step may be formed in the cutting line of the flange portion extending from the first side surface 210a.

By such a configuration, by constantly maintaining the second cutting length (e.g., d2 in FIG. 3) of the flange portion extending from the region where the first electrode terminal 212, the electrolyte injection portion 216, and the second electrode terminal 214 protrude constant, ease of processing in the cutting process of the flange portion 220 is secured, while the dead space that does not contribute to the energy capacity of the battery is reduced, thereby increasing the energy density of the secondary battery.

Referring to FIG. 5, the flange portion extending from the first side surface 210a of the receiving portion from which the first electrode terminal 212 protrudes may be cut to follow a shape in which each of the first electrode terminal 212 and the electrolyte injection portion 216 protrudes. In this case, the cutting line of the flange portion extending from the first side surface 210a may be formed outside the first electrode terminal 212, the electrolyte injection portion 216, and the second electrode terminal 214. In FIG. 5, a description for configurations overlapping with FIG. 4 is omitted.

In embodiments, the cutting line of the flange portion extending from the first side surface 210a may be determined based on the first length b1 by which the first electrode terminal 212 protrudes from the first side surface 210a and the second length b2 by which the electrolyte injection portion 216 protrudes from the first side surface 210a. For example, the cutting line of the flange portion extending from the region where the first electrode terminal 212 protrudes may protrude further than the first electrode terminal 212 by a predetermined length c1, and the cutting line of the flange portion extending from the region where the electrolyte injection portion 216 and the second electrode terminal 214 protrude may protrude further than the electrolyte injection portion 216 by a predetermined length c2. Here, each of the protrusion lengths c1 and c2 may be within 0.3 mm of each other. As an example, each of the protrusion lengths c1 and c2 may be within 0.2 mm of each other, but the protrusion lengths are not limited thereto.

In this case, a two-stage step may be formed in the cutting line of the flange portion extending from the first side surface 210a, and compared with the embodiment of FIG. 4, the energy density of the secondary battery may be further increased.

Referring to FIG. 6, the flange portion extending from the first side surface 210a of the receiving portion from which the first electrode terminal 212 protrudes may be cut to follow a shape in which each of the first electrode terminal 212, the electrolyte injection portion 216, and the second electrode terminal 214 protrudes. In this case, the cutting line of the flange portion extending from the first side surface 210a may be formed outside the first electrode terminal 212, the electrolyte injection portion 216, and the second electrode terminal 214. In FIG. 6, a description for configurations overlapping with FIGS. 4 and 5 is omitted.

In embodiments, the cutting line of the flange portion extending from the first side surface 210a may be determined based on the first length b1 by which the first electrode terminal 212 protrudes from the first side surface 210a, the second length b2 by which the electrolyte injection portion 216 protrudes from the first side surface 210a, and the third length b3 by which the second electrode terminal 214 protrudes from the first side surface 210a. For example, the cutting line of the flange portion extending from the region where the first electrode terminal 212 protrudes may protrude further than the first electrode terminal 212 by a predetermined length c1, the cutting line of the flange portion extending from the region where the electrolyte injection portion 216 protrudes may protrude further than the electrolyte injection portion 216 by a predetermined length c2, and the cutting line of the flange portion extending from the region where the second electrode terminal 214 protrudes may protrude further than the electrolyte injection portion 216 by a predetermined length c3. Here, each of the protrusion lengths c1, c2, and c3 may be within 0.3 mm of each other.

In this case, a three-stage step may be formed in the cutting line of the flange portion extending from the first side surface 210a, and compared with the embodiments of FIGS. 4 and 5, the energy density may be further increased.

In FIGS. 4-6, for convenience of description, the description has been made under an assumption that the first length b1 is longer than the second length b2 and the third length b3, but it should be appreciated that when the first length b1, the second length b2, and the third length b3 are changed, the cutting line of the flange portion may also be changed based thereon.

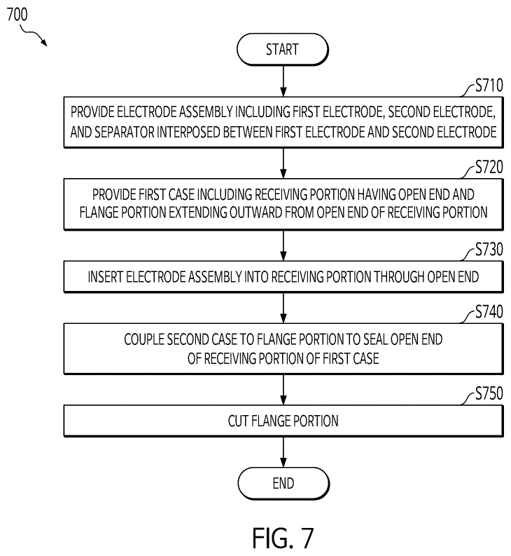

FIG. 7 is a flowchart illustrating a method 700 for manufacturing a secondary battery according to embodiments of the present disclosure. The method 700 for manufacturing a secondary battery may be initiated by providing an electrode assembly including a first electrode, a second electrode, and a separator interposed between the first electrode and the second electrode (S710). The electrode assembly may further include an electrode tab protruding toward one side of the first electrode. Thereafter, a first case including a receiving portion having an open end and a flange portion extending outward from the open end of the receiving portion may be provided (S720).

In embodiments, a first electrode terminal electrically connected to the first electrode may protrude from a first side surface of the receiving portion. The first electrode terminal may be disposed to be biased toward one side with respect to a central axis of the receiving portion along a direction in which the first electrode terminal protrudes. Further, an electrolyte injection portion may further protrude from the first side surface of the receiving portion. The electrolyte injection portion may be disposed to be biased toward the one side where the first electrode terminal is disposed with respect to the central axis of the receiving portion. Additionally, a second electrode terminal may further protrude from the first side surface of the receiving portion. The second electrode terminal may be disposed to be biased toward the one side where the first electrode terminal is disposed with respect to the central axis of the receiving portion.

Then, the electrode assembly may be inserted into the receiving portion through the open end of the receiving portion (S730). For example, an insulating member in which a through-hole is formed may be provided. Thereafter, the electrode tab of the electrode assembly may be inserted through the through-hole. Subsequently, the electrode tab may be connected to the first electrode terminal. At this time, the through-hole of the insulating member may be formed to be biased toward one side with respect to a central axis of the insulating member along the direction in which the first electrode terminal protrudes, and may be disposed at a position corresponding to the first electrode terminal.

Then, a second case may be coupled to the flange portion to seal the open end of the receiving portion of the first case (S740). Thereafter, the flange portion may be cut (S750).

In embodiments, the flange portion extending from the first side surface may be cut to follow a shape in which the first electrode terminal protrudes. For example, the flange portion extending from the first side surface may protrude further than the first electrode terminal by a predetermined length. In this case, a cutting line of the flange portion extending from the first side surface may be formed outside the shape in which the first electrode terminal protrudes.

In embodiments, the flange portion extending from the first side surface may be cut to follow a shape in which each of the first electrode terminal and the electrolyte injection portion protrudes. For example, the flange portion extending from the first side surface may protrude further than the first electrode terminal and the electrolyte injection portion by a predetermined length. In this case, the cutting line of the flange portion extending from the first side surface may be formed outside the protruding shape of each of the first electrode terminal and the electrolyte injection portion.

In embodiments, the flange portion extending from the first side surface may be cut to follow a shape in which each of the first electrode terminal and the second electrode terminal protrudes. For example, the flange portion extending from the first side surface may protrude further than the first electrode terminal and the second electrode terminal by a predetermined length. In this case, the cutting line of the flange portion extending from the first side surface may be formed outside the protruding shape of each of the first electrode terminal and the second electrode terminal.

In embodiments, the flange portion extending from the first side surface may be cut to follow a shape in which each of the first electrode terminal, the electrolyte injection portion, and the second electrode terminal protrudes. For example, the flange portion extending from the first side surface may protrude further than the first electrode terminal, the electrolyte injection portion, and the second electrode terminal by a predetermined length. In this case, the cutting line of the flange portion extending from the first side surface may be formed outside the protruding shape of each of the first electrode terminal, the electrolyte injection portion, and the second electrode terminal.

In embodiments, the flange portion extending from a second side surface may be cut to follow a shape of the second side surface. Here, the second side surface may refer to at least one of the remaining side surfaces of the receiving portion except for the first side surface. In this case, a cutting line of the flange portion extending from the second side surface may be formed outside the shape of the second side surface.

The flowchart of FIG. 7 and the herein description are merely an example of the present disclosure, and the scope of the present disclosure is not limited to the flowchart of FIG. 7 and the herein description. For example, one or more steps in the flowchart and the herein description may be added, changed, and/or deleted, the order of one or more steps may be changed, and/or one or more steps may be performed simultaneously.

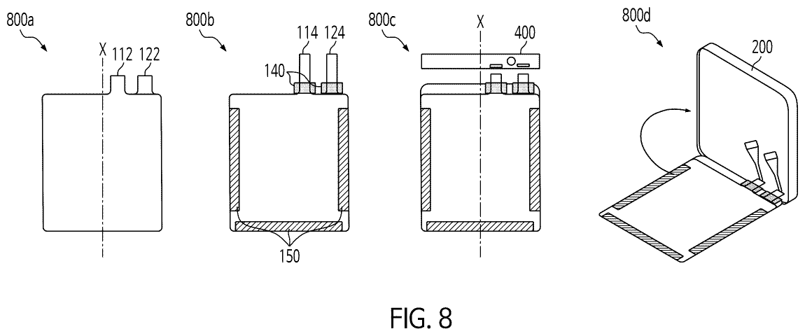

FIG. 8 illustrates an insertion process of an electrode assembly of a secondary battery according to embodiments of the present disclosure. Specifically, FIG. 8 is a view for describing step S730 of FIG. 7 in more detail.

Referring to a first example 800a, a first electrode tab 112 and a second electrode tab 122 may protrude from one surface of the electrode assembly. At this time, the first electrode tab 112 and the second electrode tab 122 may be disposed to be biased toward one side with respect to the central axis X of the electrode assembly.

Referring to a second example 800b, strip terminals 114 and 124 may be connected to each of the first electrode tab 112 and the second electrode tab 122 of the electrode assembly. An insulating film 140 may be attached to the electrode tabs 112 and 122 and the strip terminals 114 and 124. Additionally, a protective tape 150 may be attached to the surface of the electrode assembly to prevent damage to the electrode assembly and maintain the appearance of the electrode assembly.

Referring to a third example 800c, an insulating member 400 may be disposed on one surface of the electrode assembly. For example, the insulating member 400 may include a through-hole for the electrode tabs 112 and 122 and/or the strip terminals 114 and 124 to pass through.

In embodiments, the through-hole may be disposed to be biased toward one side with respect to the central axis X of the insulating member 400. Accordingly, the first electrode tab 112 and the second electrode tab 122 disposed to be biased toward one side with respect to the central axis X of the electrode assembly may pass through the through-hole of the insulating member 400.

Referring to a fourth example 800d, the first electrode tab 112 and the second electrode tab 122 may be electrically connected to the first electrode terminal and the second electrode terminal, respectively. For example, the first electrode tab 112 may be electrically connected to the first electrode terminal via a first strip terminal 114, and the second electrode tab 122 may be electrically connected to the second electrode terminal via a second strip terminal 124.

Thereafter, by rotating the electrode assembly, the electrode assembly may be inserted into the receiving portion of the first case 200. At this time, as the insulating member 400 disposed on one surface of the electrode assembly is disposed between the side surface of the receiving portion and the electrode assembly, contact between the electrode assembly and the first case 200 may be blocked.

In FIG. 8, the electrode tabs 112 and 122 are illustrated and described as being connected to the electrode terminal via the strip terminals 114 and 124, but the present disclosure is not limited thereto. For example, the electrode tabs 112 and 122 may be directly connected to the electrode terminal in some embodiments.

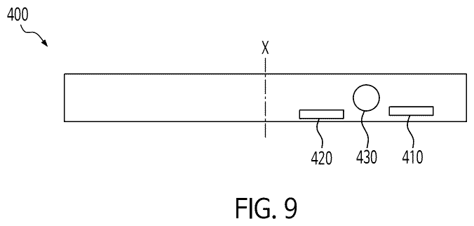

FIG. 9 illustrates an example of the insulating member 400 according to embodiments of the present disclosure. FIG. 9 is a view for describing the insulating member 400 shown in FIG. 8 in more detail.

Referring to FIG. 9, the insulating member 400 may have a substantially rectangular shape. The insulating member 400 may have a rectangular shape that is longer in one direction than in other directions, but the configuration of the insulating member 400 is not limited thereto. For example, the insulating member 400 may be formed in a shape and/or size corresponding to one side surface (e.g., 210a in FIG. 2) of the receiving portion. Accordingly, the insulating member 400 may provide electrical insulation between the electrode assembly and the first case. The insulating member 400 may be composed of a material such as PP (Polypropylene), PET (Polyethylene Terephthalate), PEEK (Polyether Ether Ketone), PI (Polyimide), etc., but the insulating member 400 not limited thereto.

In embodiments, the insulating member 400 may include a first through-hole 410, a second through-hole 420, and a third through-hole 430. The first electrode tab and/or a strip terminal connected to the first electrode tab may be inserted through the first through-hole 410 to pass through the insulating member 400. Further, the second electrode tab and/or a strip terminal connected to the second electrode tab may be inserted through the second through-hole 420 to pass through the insulating member 400. The third through-hole 430 may be formed at a position corresponding to the electrolyte injection portion (e.g., 216 in FIG. 2), but is not limited thereto.

According to embodiments, the first through-hole 410, the second through-hole 420, and the third through-hole 430 may be disposed to be biased toward one side with respect to the central axis X of the insulating member. For example, the first through-hole 410, the second through-hole 420, and the third through-hole 430 may be disposed at corresponding positions of each of the first electrode terminal, the second electrode terminal, and the electrolyte injection portion disposed to be biased toward one side of the electrode assembly.

In FIG. 9, the first through-hole 410 and the second through-hole 420 are illustrated as being substantially rectangular and the third through-hole 430 is illustrated as being circular, but the present disclosure is not limited thereto, and the size and/or shape of the through-holes 410, 420, and 430 may be changed according to design.

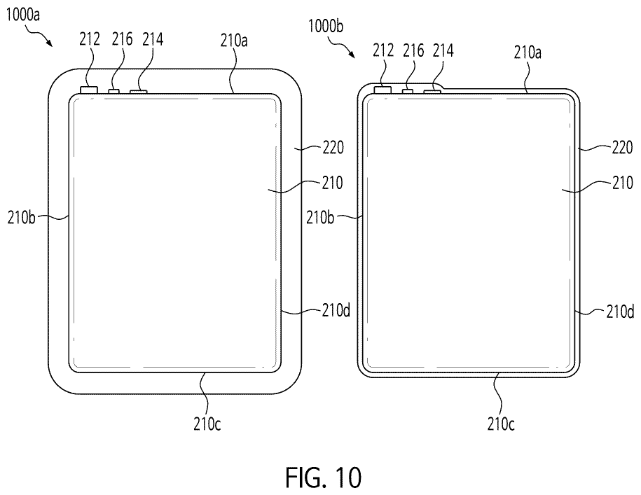

FIG. 10 illustrates a process in which the flange portion 220 is cut according to embodiments of the present disclosure. FIG. 10 may be a view for describing step S750 of FIG. 7 in more detail. A first example 1000a is a view illustrating a secondary battery in a state before the flange portion 220 is cut, and a second example 1000b is a view illustrating the secondary battery in a state after the flange portion 220 is cut.

Referring to the first example 1000a and the second example 1000b, the first electrode terminal 212, the second electrode terminal 214, and the electrolyte injection portion 216 may protrude from the first side surface 210a of the receiving portion 210.

In embodiments, the flange portion 220 may be cut by a laser irradiation method. The cutting line of the flange portion 220 may be formed outside the side surfaces 210a, 210b, 210c, and 210d of the receiving portion. For example, the flange portion 220 may be cut to be spaced apart by a predetermined length based on a welding line between the flange portion 220 and the second case (e.g., 300 in FIG. 1).

Meanwhile, the cutting line of the flange portion extending from the first side surface 210a of the receiving portion may be formed outside the first electrode terminal 212, the second electrode terminal 214, and the electrolyte injection portion 216 so as not to interfere with the first electrode terminal 212, the second electrode terminal 214, and the electrolyte injection portion 216. When the first electrode terminal 212, the second electrode terminal 214, and the electrolyte injection portion 216 are disposed to be biased toward one side of the first side surface 210a, the cutting length of the flange portion 220 may be shortened in a region where the first electrode terminal 212, the second electrode terminal 214, and the electrolyte injection portion 216 do not protrude from the first side surface 210a, and accordingly, the energy efficiency of the battery may be improved.

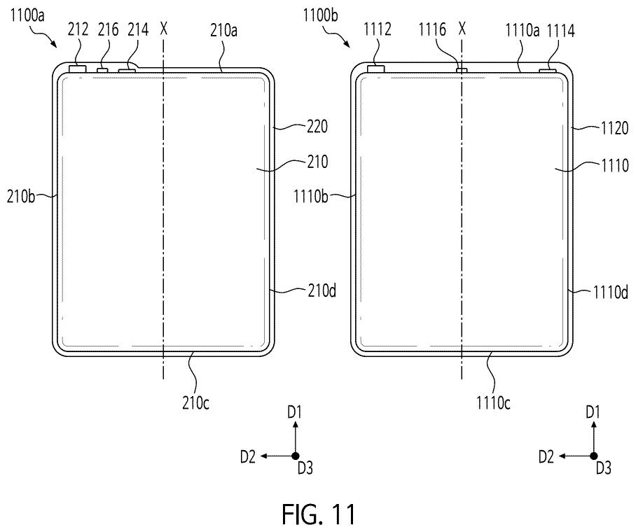

FIG. 11 illustrates a secondary battery according to embodiments of the present disclosure and a secondary battery according to a comparative example. A first example 1100a illustrates a secondary battery according to embodiments of the present disclosure, and a second example 1100b illustrates a secondary battery according to a comparative example.

Referring to the first example 1100a, the first electrode terminal 212, the second electrode terminal 214, and the electrolyte injection portion 216 may protrude from the first side surface 210a among the side surfaces 210a, 210b, 210c, and 210d of the receiving portion 210. Referring to the first example 1100a, the first electrode terminal 212, the second electrode terminal 214, and the electrolyte injection portion 216 may be disposed to be biased toward one side with respect to the central axis X of the receiving portion 210 along the direction (e.g., the D1 direction) in which the first electrode terminal 212 protrudes. In this case, the cutting length of the flange portion 220 may be shortened in a region where the first electrode terminal 212, the second electrode terminal 214, and the electrolyte injection portion 216 do not protrude.

Referring to the second example 1100b, the first electrode terminal 1112, the second electrode terminal 1114, and the electrolyte injection portion 1116 may protrude from the first side surface 1110a among side surfaces 1110a, 1110b, 1110c, and 1110d of a receiving portion 1110. At this time, when the first electrode terminal 1112, the second electrode terminal 1114, and the electrolyte injection portion 1116 are disposed to be dispersed on the first side surface 1110a, the cutting line of a flange portion 1120 extending from the first side surface 1110a may be formed outside compared to the first example 1100a. In this case, as a region that does not contribute to the battery capacity is expanded, the volume of the secondary battery is unnecessarily increased, and thus the energy efficiency of the secondary battery may be lowered.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

What is claimed is:

1. A secondary battery comprising:
an electrode assembly including a first electrode, a second electrode, and a separator interposed between the first electrode and the second electrode;
a first case accommodating the electrode assembly and comprising a receiving portion having an open end and a flange portion extending outward from the open end of the receiving portion; and
a second case coupled to the flange portion to seal the open end of the receiving portion,
wherein a first electrode terminal electrically connected to the first electrode protrudes from a first side surface of the receiving portion,
the first electrode terminal is biased toward one side with respect to a central axis of the receiving portion along a direction in which the first electrode terminal protrudes, and
the flange portion extending from the first side surface is cut to follow a shape in which the first electrode terminal protrudes.

2. The secondary battery as claimed in claim 1, further comprising an electrolyte injection portion that further protrudes from the first side surface, wherein
the electrolyte injection portion is biased toward the one side on which the first electrode terminal is disposed with respect to the central axis, and
the flange portion extending from the first side surface is cut to follow a protruding shape of each of the first electrode terminal and the electrolyte injection portion.

3. The secondary battery as claimed in claim 2, wherein a first length by which the first electrode terminal is spaced apart from the central axis is greater than or equal to a second length by which the electrolyte injection portion is spaced apart from the central axis.

4. The secondary battery as claimed in claim 2, wherein a first length by which the first electrode terminal protrudes from the first side surface is greater than or equal to a second length by which the electrolyte injection portion protrudes from the first side surface.

5. The secondary battery as claimed in claim 2, further comprising a second electrode terminal electrically connected to the second electrode that further protrudes from the first side surface, wherein
the second electrode terminal is biased toward the one side on which the first electrode terminal is disposed with respect to the central axis, and
the flange portion extending from the first side surface is cut to follow a protruding shape of each of the first electrode terminal, the electrolyte injection portion, and the second electrode terminal.

6. The secondary battery as claimed in claim 5, wherein a second length by which the electrolyte injection portion is spaced apart from the central axis is less than or equal to a first length by which the first electrode terminal is spaced apart from the central axis, and greater than or equal to a third length by which the second electrode terminal is spaced apart from the central axis.

7. The secondary battery as claimed in claim 5, wherein a second length by which the electrolyte injection portion protrudes from the first side surface is less than or equal to a first length by which the first electrode terminal protrudes from the first side surface, and greater than or equal to a third length by which the second electrode terminal protrudes from the first side surface.

8. The secondary battery as claimed in claim 1, further comprising a second electrode terminal electrically connected to the second electrode that further protrudes from the first side surface, wherein
the second electrode terminal is biased toward the one side on which the first electrode terminal is disposed with respect to the central axis, and
the flange portion extending from the first side surface is cut to follow a protruding shape of each of the first electrode terminal and the second electrode terminal.

9. The secondary battery as claimed in claim 1, wherein a cutting line of the flange portion extending from the first side surface is formed outside the protruding shape in which the first electrode terminal protrudes such that the flange portion extending from the first side surface protrudes further than the first electrode terminal by a predetermined length.

10. The secondary battery as claimed in claim 1, wherein the flange portion extending from a second side surface of the receiving portion is cut to follow a shape of the second side surface.

11. The secondary battery as claimed in claim 10, wherein a cutting line of the flange portion extending from the second side surface is formed outside the protruding shape of the second side surface such that the flange portion extending from the second side surface protrudes further than the second side surface by a predetermined length.

12. The secondary battery as claimed in claim 1, further comprising an insulating member in which a through-hole is formed, wherein the insulating member is disposed between the first side surface of the receiving portion and the electrode assembly.

13. The secondary battery as claimed in claim 12, wherein the electrode assembly further comprises an electrode tab protruding toward one side of the first electrode to be connected to the first electrode terminal, and wherein the electrode tab passes through the insulating member through the through-hole.

14. The secondary battery as claimed in claim 13, wherein the through-hole is formed to be biased toward one side with respect to a central axis of the insulating member along a direction in which the first electrode terminal protrudes, and is disposed at a position corresponding to the first electrode terminal.

15. The secondary battery as claimed in claim 1, wherein at least a portion of the first case and the second case comprises stainless steel (SUS).

16. A method for manufacturing a secondary battery, comprising:
providing an electrode assembly comprising a first electrode, a second electrode, and a separator interposed between the first electrode and the second electrode;
providing a first case comprising a receiving portion having an open end and a flange portion extending outward from the open end of the receiving portion;
inserting the electrode assembly into the receiving portion through the open end;
coupling a second case to the flange portion to seal the open end of the receiving portion; and
cutting the flange portion,
wherein a first electrode terminal electrically connected to the first electrode protrudes from a first side surface of the receiving portion,
the first electrode terminal is biased toward one side with respect to a central axis of the receiving portion along a direction in which the first electrode terminal protrudes, and
the cutting the flange portion comprises cutting the flange portion extending from the first side surface to follow a shape in which the first electrode terminal protrudes.

17. The method for manufacturing a secondary battery as claimed in claim 16, wherein an electrolyte injection portion further protrudes from the first side surface,
the electrolyte injection portion is biased toward the one side on which the first electrode terminal is disposed with respect to the central axis, and
the cutting the flange portion further comprises cutting the flange portion extending from the first side surface to follow a shape in which the electrolyte injection portion protrudes.

18. The method for manufacturing a secondary battery as claimed in claim 16, wherein the cutting the flange portion extending from the first side surface to follow the shape in which the first electrode terminal protrudes comprises forming a cutting line of the flange portion extending from the first side surface outside the shape in which the first electrode terminal protrudes such that the flange portion extending from the first side surface protrudes further than the first electrode terminal by a predetermined length.

19. The method for manufacturing a secondary battery as claimed in claim 16, wherein the cutting the flange portion further comprises cutting the flange portion extending from a second side surface of the receiving portion to follow a shape of the second side surface.

20. The method for manufacturing a secondary battery as claimed in claim 16, wherein the electrode assembly further comprises an electrode tab protruding toward one side of the first electrode, and
the inserting the electrode assembly comprises:
providing an insulating member in which a through-hole is formed;
inserting the electrode tab through the through-hole; and
connecting the electrode tab to the first electrode terminal,
wherein the through-hole is formed to be biased toward one side with respect to a central axis of the insulating member along a direction in which the first electrode terminal protrudes, and is disposed at a position corresponding to the first electrode terminal.
